(19) United States
(12) Patent Application Publication
(10) Pub. No.: US 2009/0073898 A1
(43) Pub. Date: Mar. 19, 2009

(54) METHOD AND APPARATUS FOR CODE DIVISION DUPLEXING

(76) Inventor: Byung Keun LIM, Kyungki-do (KR)

Correspondence Address: KED & ASSOCIATES, LLP, P.O. Box 221200, Chantilly, VA, 20153-1200, US

(21) Appl. No.: 12/272,375

(22) Filed: Nov. 17, 2008

Related U.S. Application Data
(63) Continuation of application No. 09/189,793, filed on Nov. 12, 1998.

(30) Foreign Application Priority Data
Dec. 31, 1997 (KR) 82211/1997

(51) Int. Cl. H04L 5/14

(52) U.S. Cl. 370/276

(57) ABSTRACT

A method and apparatus for providing a bi-directional communication in a mobile communication system by a Code Division Duplexing. In the Code Division Duplexing, the data to be transmitted is incorporated with unique codes having an orthogonal property to designate a forward and reverse direction communication, thereby allowing a bi-directional communication. Because the data can be efficiently transmitted through one channel, the Code Division Duplexing can provide a bi-directional communication for low tier bandwidth channels such as private and ISM communication systems.

### FIELD OF INVENTION

The present invention relates to channel assignment using a Code Division Duplexing and more particularly to assigning the forward and reverse channel directions by a Code Division Duplexing.

### BACKGROUND OF INVENTION

Generally, a mobile communication system allows multiple users to communicate simultaneously regardless of the time and the place. Such communication is achieved through a Multiple Access method which enables multiple user connections. The Frequency Division Multiple Access (FDMA), the Time Division Multiple Access (TDMA), the Code Division Multiple Access (CDMA), or a mixture of the FDMA, TDMA, and CDMA are Multiple Access methods allowing multiple users to share a single channel by simultaneous connections. Moreover, a mobile communication system allows a bi-directional communication by the Frequency Division Duplexing (FDD) or the Time Division Duplexing (TDD).

Specifically, the FDMA is an analog wireless communication system which divides the bandwidth spectrum into a plurality of channels. A simultaneous communication is allowed by assigning the channels without overlap to individual users, thereby allowing multiple access to share one common bandwidth. For example, FIG. 1(a) shows a bandwidth division using the FDMA/FDD. The total band is divided into an upper and lower bandwidths and as shown in FIG. 1(a), one bandwidth is for a forward direction communication channel while the other is for a reverse direction communication channel. Also, a fixed amount of bandwidth is reserved to maintain a distance between the forward and reverse directions. Moreover, one frequency bandwidth is divided into a plurality of sub bandwidths and each sub-bandwidth is considered as a single communication channel to transmit data without regard to the time. However, because the physical width of the band is limited, the number of channels are necessarily limited, resulting in a limited number of users.

In contrast, the TDMA allows multiple users to share a common bandwidth by dividing the time for transmission. Thus, a simultaneous communication is allowed through one channel, as shown in FIG. 1(b), by assigning different time slots to individual users. By one channel, a series of pulses are transmitted in intervals without overlap using time slots rather than a plurality of frequency divisions. Unlike the FDMA/FDD, the bandwidth is not divided into upper and lower bandwidths for forward and reverse communication channels. Instead, in the TDMA/TDD, each time slot is further divided into a plurality of bits and for the duration of each bit, the bandwidth is assigned as either the forward or reverse direction communication channel. In FIG. 2, one time slot is divided into 8 bits and for the duration of the first to fourth bits, the channel transmits in a forward direction and for the duration of the fifth to eighth bits, the channel transmits in a reverse direction. Because the FDMA is limited by the physical size of the bandwidth, the TDMA allows approximately three times more users connections than the FDMA.

The multiple access and channel duplexing methods as described above are sufficient for a high tier communication bandwidths. However, the wireless communication for private and the Industry Scientific Medical (ISM) are achieved through an Unlicensed RF Band which is a low tier communication bandwidth. Because the low tier communication bandwidths are limited in size, the bandwidth is insufficient for communication systems using the FDD method which divides the bandwidth for forward and reverse direction communication channels. Thus, for low tier communications, the FDD method cannot sufficiently provide a bi-directional communication.

### OBJECTIVES OF THE INVENTION

Accordingly, an object of the present invention is to solve at least the problems and disadvantages of the related art.

Particularly, an object of the present invention is provide a duplexing method for private and ISM communication systems.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWING

The invention will be described in detail with reference to the following drawings in which like reference numerals refer to like elements wherein:

FIG. 1(a) shows a bandwidth division for a FDMA.

FIG. 1(b) shows a use of a bandwidth for a TDMA.

FIG. 2 shows a time division of a bandwidth for a TDMA.

FIG. 3 shows a preferred embodiment of a communication system using the CDD method according to the present invention.

FIG. 4 shows an example of code assignment for a communication system using the CDD method

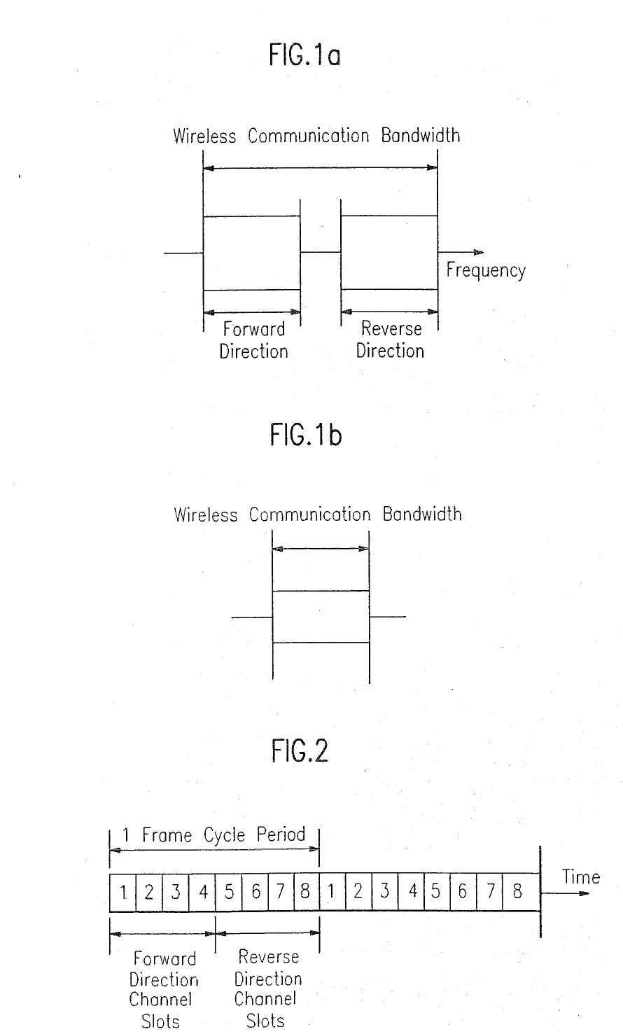

### DETAILED DESCRIPTION OF THE INVENTION

As discussed above, the duplexing methods available in the related art were FDD and TDD. The present invention is an alternative duplexing method, namely a Code Division Duplexing (CDD), which can sufficiently provide a bi-directional communications for low tier bandwidths such as the private and the ISM communication systems.

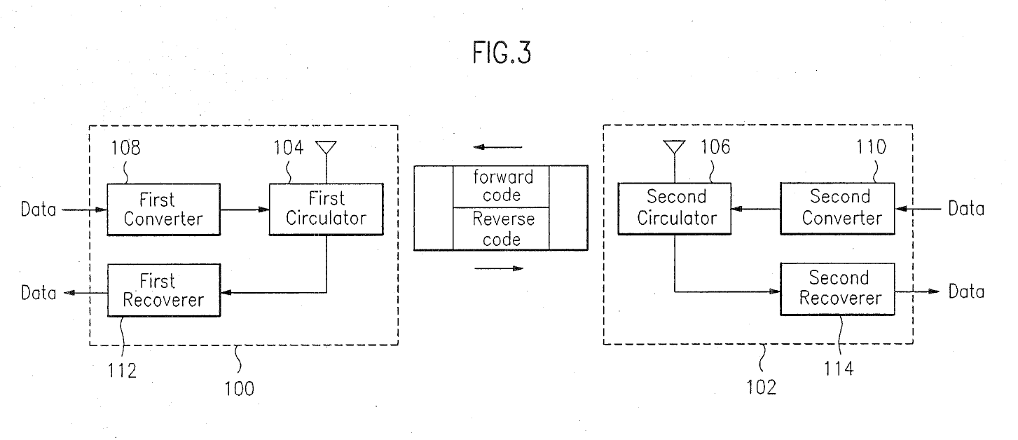

Generally, a low tier communication bandwidth provides sufficient bandwidth for one frequency channel. Thus, one channel must serve as both the forward and reverse direction communication channel. Accordingly, the CDD method allows a bi-directional communication through one channel by assigning codes to indicate a forward direction communication channel or a reverse direction communication channel. FIG. 3 shows a preferred embodiment of a communication system using the CDD method according to the present invention, including a base station 100, a mobile station 102, a forward and reverse communication channels. The base station 100 and the mobile station 102 further includes a first circulator 104 and a second circulator 106; a first converter 108 and a second converter 110; and a first recoverer 112 and a second recoverer 114 respectively.

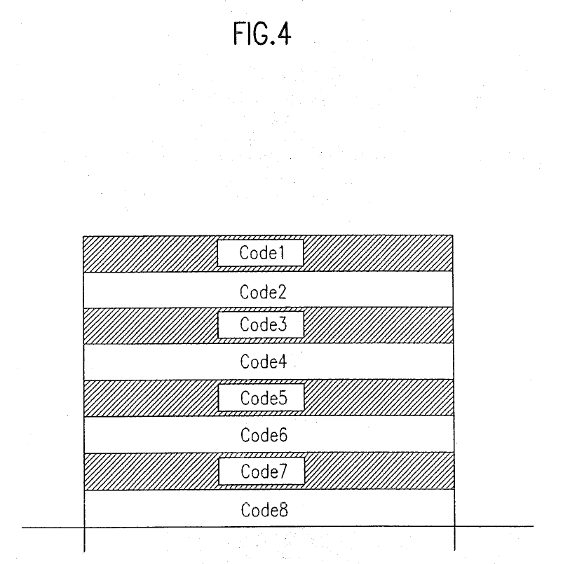

Particularly, N number of unique codes are assigned to a channel and within the N number of codes, some are designated to indicate a forward direction and some are designated to indicate a reverse direction communication channel. FIG. 4 shows an example of code assignment for a bi-directional communication system using the CDD method. The codes 1, 3, 5 and 7 indicate a forward direction communication channel and the codes 2, 4, 6 and 8 indicate a reverse direction communication channel.

The forward and reverse direction radio signals are incorporated into the data transmitted and received between the base station 100 and the mobile station 102 by the first and second converters 108, 110. During the transmittal and receipt of the data, the first and second circulators 104, 106 distinguish the forward and reverse direction codes and appropriately forward the data to the antenna to be transmitted or to the recoverer to be received. The first and second recoverers 112, 114 extract the incorporated code to recover the original data.

For a bi-directional transmission of data, each user has a unique code for forward and reverse direction communication. Spreading to transmit and despreading to receive the data with unique codes of Mbits allow multiple users to share a common channel. Thus, when data is transmitted from the base-station 100 to the mobile station 102, all data with codes indicating a reverse direction communication are transmitted together through one channel by spreading. The transmitted data is received at the mobile station 102 by despreading using the same unique codes. Similarly, when the data is transmitted from the mobile station 102 to the base station 100, all data with codes indicating a forward direction communication are transmitted together through one channel by spreading and received at the base station 100 by despreading using the same unique codes.

Having an orthogonal property, multiplication of two different codes results in a zero value, but a value of one is obtained when two same unique code are multiplied. Accordingly, each users converts the data to be transmitted with a unique code either for forward or reverse direction communication. As discussed above, the converted data of multiple users are transmitted together. Once transmitted, the appropriate data for each user can be recovered by multiplying the data stream with the same unique code used to convert the data. Because of the orthogonal property, only the data with the same unique code will be received with a value of one. Therefore, a bi-directional communication between the base station 100 and the mobile station 102 is achieved through one channel by spreading and despreading using unique codes assigned to the users.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

1-14. (canceled)

15. A system comprising:
a plurality of reverse communication channels; and
a plurality of forward communication channels, wherein:
each of the plurality of reverse communication channels and each of the plurality of forward communication channels utilize one common frequency;
each of the plurality of reverse communication channels having a unique code to identify the channel as a reverse communication channel and each of the plurality of forward communication channels having a unique code to identify the channel as a forward communication channel; and
the plurality of reverse communication channels and plurality of forward channels carry data simultaneously.

16. The system of claim 15, wherein each unique code is one of a plurality of mutually orthogonal codes.

17. The system of claim 15, wherein:
each of the reverse communication channels is a communication channel for carrying data from a mobile terminal to a base station; and
each of the forward communication channels is a communication channel for carrying data from a base station to a mobile terminal.

18. An apparatus comprising:
a transmitter configured to transmit data on a first reverse communication channel; and
a receiver configured to receive data on a first forward communication channel, wherein:
the first reverse communication channel, a second reverse communication channel, the first forward communication channel and a second forward communication channel utilize one frequency channel;
the first reverse communication channel having a first unique code to identify the channel as a reverse communication channel, the second reverse communication channel having a second unique code to identify the channel as a reverse communication channel, the forward communication channel having a third unique code to identify the channel as a forward communication channel and the fourth reverse communication channel having a fourth unique code to identify the channel as a forward communication channel; and
the first reverse communication channel, the second reverse communication channel, the first forward communication channel and the fourth forward communication channel are configured to carry data simultaneously.

19. The apparatus of claim 18, wherein each unique code is one of a plurality of mutually orthogonal codes.

20. The apparatus of claim 18, wherein the apparatus is a mobile terminal.

21. An apparatus comprising:
a transmitter configured to transmit data on a plurality of forward communication channels; and
a receiver configured to receive data on a plurality of reverse communication channels, wherein:
each of the plurality of reverse communication channels and each of the plurality of forward communication channels utilize one frequency channel;
each of the plurality of reverse communication channels having a unique code to identify the channel as a reverse communication channel and each of the forward communication channels having a unique code to identify the channel as a forward communication channel; and
the reverse communication channels and the forward communication channels are configured to carry data simultaneously.

22. The apparatus of claim 21, wherein each unique code is one of a plurality of mutually orthogonal codes.

23. The apparatus of claim 21, wherein the apparatus is a base station.

24. An apparatus comprising:
a transmitter configured to transmit data on a common channel; and
a receiver configured to receive data on the common channel, wherein the common channel includes:
a first reverse communication channel, a second reverse communication channel, a first forward communication channel and a second forward communication channel that utilize one common channel;
the first reverse communication channel having a first unique code to identify the channel as a reverse communication channel, the second reverse communication channel having a second unique code to identify the channel as a reverse communication channel, the forward communication channel having a third unique code to identify the channel as a forward communication channel and the fourth reverse communication channel having a fourth unique code to identify the channel as a forward communication channel; and
the first reverse communication channel, the second reverse communication channel, the first forward communication channel and the fourth forward communication channel are configured to carry data simultaneously.

25. The system of claim 15, wherein the unique code to identify the channel as a reverse communication channel is different for each of the plurality of reverse communication channels of the one frequency channel, and the unique code to identify the channel as a forward communication channel is different for each of the plurality of forward communication channels of the one frequency channel.

26. The system of claim 21, wherein the unique code to identify the channel as a reverse communication channel is different for each of the plurality of reverse communication channels of the one frequency channel, and the unique code to identify the channel as a forward communication channel is different for each of the plurality of forward communication channels of the one frequency channel.

27. The apparatus of claim 18, wherein each of the first unique code, the second unique code, the third unique code and the fourth unique code are different.

28. The apparatus of claim 24, wherein each of the first unique code, the second unique code, the third unique code and the fourth unique code are different.
